(19) United States
(12) Patent Application Publication
(10) Pub. No.: US 2002/0192043 A1
(43) Pub. Date: Dec. 19, 2002

(54) Power hand drill

(76) Inventor: Yuan-Ho Lin, Ta Li City (TW)

Correspondence Address: Hart, Baxley Daniels & Holton, 59 John Street, Fifth Floor, New York, NY, 10038, US

(21) Appl. No.: 09/879,450

(22) Filed: Jun. 13, 2001

(51) Int. Cl. B23B 45/00

(52) U.S. Cl. 408/124; 408/239 R

(57) ABSTRACT

A power hand drill includes a motor housing, a coupling block, a torque adjustment ring, and a chuck and driving shaft unit, the driving shaft of the chuck and driving shaft unit having a rear extension coupling rod inserted through the coupling block and coupled to the power output end of the motor in the motor housing, the coupling block having a mounting hole into which a holding down screw is threaded to force a steel ball into engagement with an annular groove around the periphery of the rear extension rod of the driving shaft to prohibit the driving shaft from axial movement relative to the coupling block.

### BACKGROUND OF THE INVENTION

The present invention relates to a power hand drill and, more particularly, to such a power hand drill in which the driving shaft is coupled to the chuck and detachably connected with the chuck to the output end of the motor.

A conventional power hand drill, as shown in FIG. 1, comprises a motor housing, a chuck, a transmission shaft mounted in the motor housing and coupled to the output shaft of the motor in the motor housing through a planetary gear set, the transmission shaft having an outer thread at the front end thereof, and a driving shaft mounted in the chuck, the driving shaft having an inner thread disposed in the rear end thereof and threaded onto the outer thread of the transmission shaft. Because the transmission shaft and the driving shaft are separately fabricated, the manufacturing cost of this structure of power hand drill is high. In order to stabilize the connection between the chuck and the motor housing, the inner thread of the driving shaft and the outer thread of the transmission shaft must have a certain length. After the outer thread and the inner thread have been tightly fastened together, it is difficult to remove the chuck from the motor housing. Further, replacing the bit is also inconvenient.

### SUMMARY OF THE INVENTION

The present invention provides a power hand drill, which eliminates the aforesaid drawbacks. It is one object of the present invention to provide a power hand drill, which is easy to assemble and inexpensive to manufacture. It is another object of the present invention to provide a power hand drill, which eliminates power loss during its forward or backward action. It is still another object of the present invention to provide a power hand drill, which achieve smooth rotation of the driving shaft when operated. To achieve these and other objects of the present invention, the power hand drill comprises a motor housing, a coupling block, a torque adjustment ring, and a chuck and driving shaft unit, the driving shaft of the chuck and driving shaft unit having a rear extension coupling rod inserted through the coupling block and coupled to the power output end of the motor in the motor housing, the coupling block having a mounting hole into which a holding down screw is threaded to force a steel ball into engagement with an annular groove around the periphery of the rear extension rod of the driving shaft to prohibit the driving shaft from axial movement relative to the coupling block.

### BRIEF DESCRIPTION OF THE DRAWINGS

FIG. 1 is an exploded view of a power hand drill according to the prior art.

FIG. 2 is an elevational view of a power hand drill constructed according to a first embodiment of the present invention, showing the chuck and driving shaft unit disconnected from the coupling block and the motor housing.

FIG. 3 is an exploded view of the power hand drill according to the first embodiment of the present invention.

FIG. 4 is a sectional plain view of the power hand drill according to the first embodiment of the present invention.

FIG. 5 is a sectional view taken along line 5-5 of FIG. 4.

FIG. 6 is a sectional plain view of a power hand drill according to a second embodiment of the present invention.

FIG. 7 is a sectional view taken along line 7-7 of FIG. 6.

FIG. 8 is a sectional plain view of a power hand drill according to a third embodiment of the present invention.

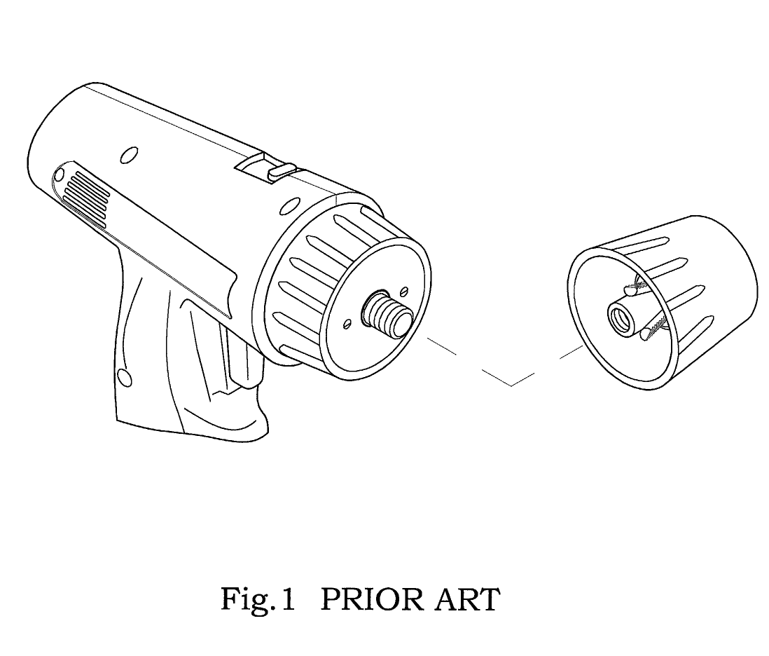

### DETAILED DESCRIPTION OF THE PREFERRED EMBODIMENT

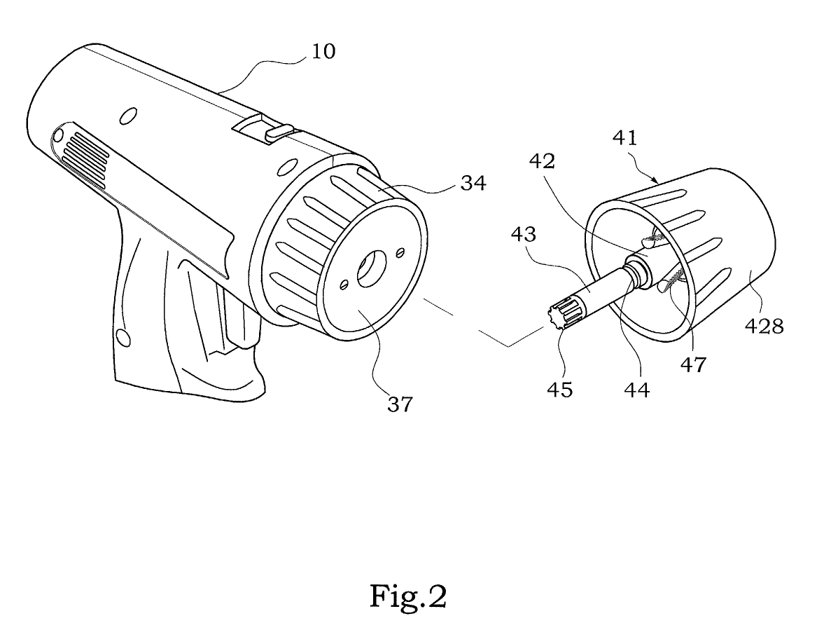

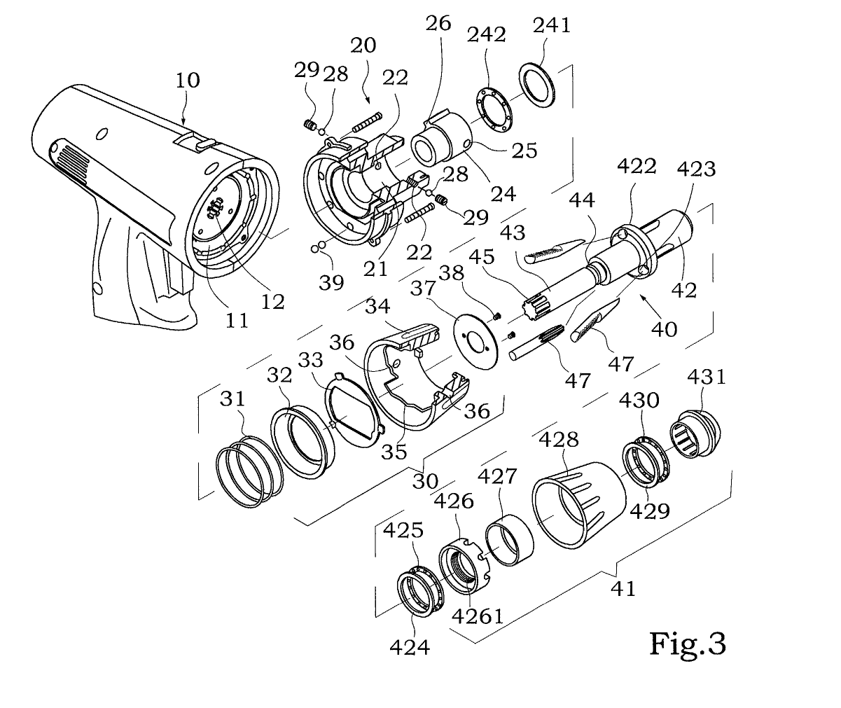

Referring to FIGS. 2 and 3, a power hand drill is shown comprising:

a motor housing 10 holding a motor (not shown) on the inside, which motor having a planetary gear set 11 coupled to its output shaft, which planetary gear set 11 having a toothed coupling hole 12 in its output end;

a coupling block 20 fixedly fastened to the front side of the motor housing 10, the coupling block 20 comprising a forwardly extended front coupling tube 21, the front coupling tube 21 having at least one, for example, two radial mounting holes 22 and a longitudinally extended locating groove 23 (see FIG. 5);

an oil-contained bushing 24 mounted in the front coupling tube 21 of the coupling block 20, the oil-contained bushing 24 having a longitudinal rib 26 coupled to the locating groove 23 of the front coupling tube 21 of the coupling block 20 and two radial through holes 25 corresponding to the radial mounting holes 22 of the front coupling tube 21 of the coupling block 20;

a torque adjustment unit 30, the torque adjustment unit 30 being comprised of a spring 31, a hollow spring holder 32, an adjustment plate 33, an adjustment ring 34, and an annular locating plate 37, the adjustment ring 34 having a curved track 35 and two radial through holes 36 aligned at two sides corresponding to the mounting holes 22 of the front coupling tube 21 of the coupling block 20, the locating plate 37 being fixedly fastened to the front side of the front coupling tube 21 of the coupling block 20 by screws 38, the spring 31, hollow spring holder 32, adjustment plate 33 and adjustment ring 34 being set between the coupling block 20 and the locating plate 37 such that rotating the adjustment ring 34 causes the adjustment plate 33 to be forced by the curved track 35 of adjustment ring 34 to move the spring holder 32 axially forwards or backwards and to further compress or release the spring 31 (the structure and function of the torque adjustment ring 30 are similar to the conventional designs and not within the scope of the present invention);

two steel balls 28 respectively inserted through the radial through holes 36 of the adjustment ring 34 and the mounting holes 22 of the front coupling tube 21 of the coupling block 20 into the radial through holes 25 of the oil-contained bushing 24;

two holding down screws 29 respectively inserted through the radial through holes 36 of the adjustment ring 34 and threaded into the mounting holes 22 of the front coupling tube 21 of the coupling block 20 to stop the steel balls 28 inside the oil-contained bushing 24 (enabling the steel balls 28 to stop a driving shaft from axial movement); and

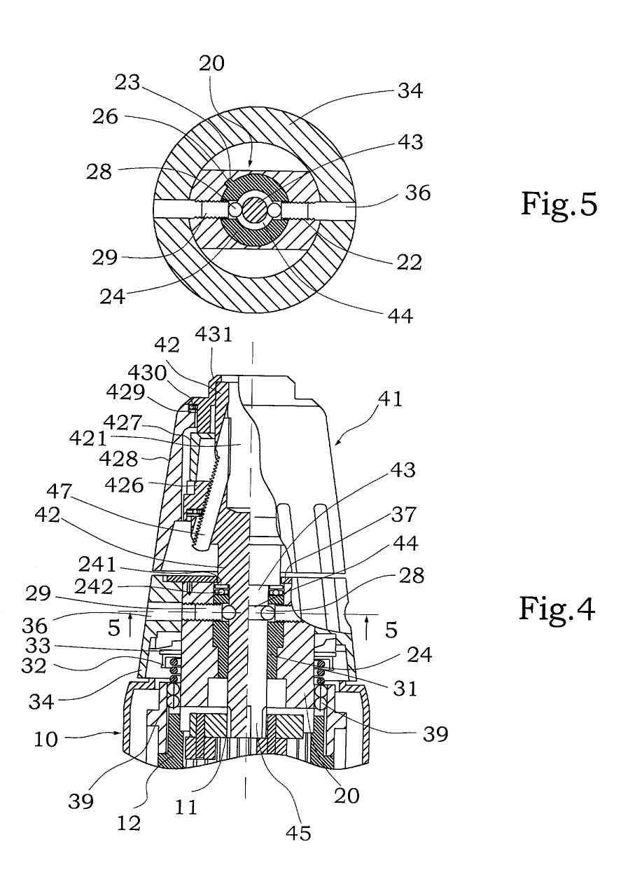

a chuck and driving shaft unit 40, the chuck and driving shaft unit 40 being comprised of a chuck assembly 41, a driving shaft 42, and a plurality of peripherally threaded pawls 47, the driving shaft 42 comprising an axially extended front coupling hole 421 (see FIG. 4) adapted to receive a bit, a collar 422 around the periphery, a plurality of oblique through holes 423 respectively extended through the collar 422 into communication with the front coupling hole 421 and adapted to receive the pawls 47 for enabling the pawls 47 to be respectively forced into engagement with the periphery of the bit being inserted into the front coupling hole 421, and a rear extension coupling rod 43, the rear extension coupling rod 43 having an annular groove 44 extended around the periphery thereof on the middle and adapted to receive the steel balls 28 for enabling the steel balls 28 to stop the driving shaft 42 from axial movement and a toothed coupling end 45 engaged into the toothed coupling hole 12 of the planetary gear set 11 of the motor housing 10, the chuck assembly 41 comprising a first gasket ring 424 supported on the collar 422 of the driving shaft 42, a first ball bearing 425 supported on the first gasket ring 424, a nut 426 supported on the first ball bearing 425, the nut 426 having an inner thread 4261 threaded onto the peripherally threaded pawls 47, a stop ring 427 stopping the nut 426 at one side, a chuck shell 428 press-fitted onto the stop ring 427 and the nut 426 for rotating the nut 426 to move the pawls 47 forwards/backwards relative to the bit, a second gasket ring 429 supported on the front side of the check shell 428, a second ball bearing 430 supported on the second gasket ring 429, and an end cap 431 supported on the second ball bearing 430 and fastened to the front side of the driving shaft 42.

Further, a ball bearing 242 is supported between the oil-contained bushing 24 and the chuck and driving shaft unit 40, and a washer 241 is supported between the ball bearing 242 and the chuck and driving shaft unit 40.

The use of the present invention is outlined hereinafter with reference to FIGS. 4 and 5. When in use, the driving shaft 42 of the chuck and driving shaft unit 40 is inserted through the annular locating plate 37 into the coupling block 20 to force the toothed coupling end 45 into engagement with the toothed coupling hole 12 of the planetary gear set 11 of the motor housing 10, and then the steel balls 28 are respectively inserted through the through holes 36 of the adjustment ring 34 and the mounting holes 22 of the front coupling tube 21 of the coupling block 20 into the radial through holes 25 of the oil-contained bushing 24, and the holding down screws 29 are respectively inserted through the through holes 36 of the adjustment ring 34 and threaded into the mounting holes 22 of the front coupling tube 21 of the coupling block 20 to force the steel balls 28 into engagement with the annular groove 44 of the driving shaft 42, and thus the chuck and driving shaft unit 40 is positively secured to the motor housing 10. When not in use, the adjustment ring 34 is rotated to aim the through holes 36 at the mounting holes 22 of the front coupling tube 21 of the coupling block 20, and then a screw driver is used to remove the holding down screws 29 from the mounting holes 22 for enabling the steel balls 28 to be respectively poured out of the oil-contained bushing 24 and the coupling block 20 so that the chuck and driving shaft unit 40 can be directly removed from the motor housing 10. This structure of motor hand drill is easy to assemble and inexpensive to manufacture. The motor hand drill eliminates power loss during its forward or backward action. Further, the chuck and driving shaft unit 40 can easily be installed in the motor housing 10 or removed from the motor housing 10.

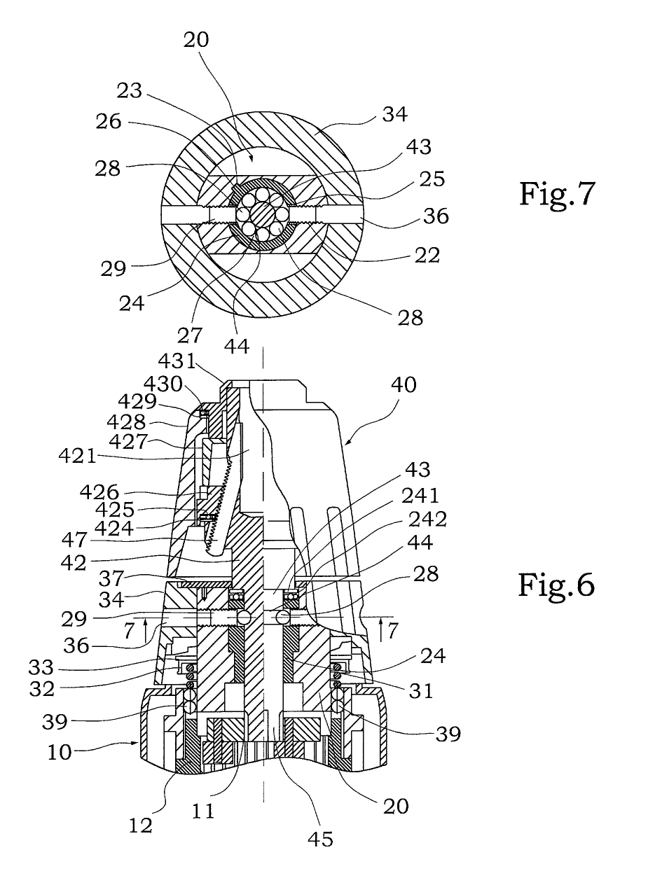

FIGS. 6 and 7 show an alternate form of the present invention. According to this alternate form, the oil-contained bushing 24 comprises an inside annular groove 27 extended around the inside wall thereof across the radial through holes 25 and adapted to match the annular groove 44 of the driving shaft 42 and to receive the steel balls 28.

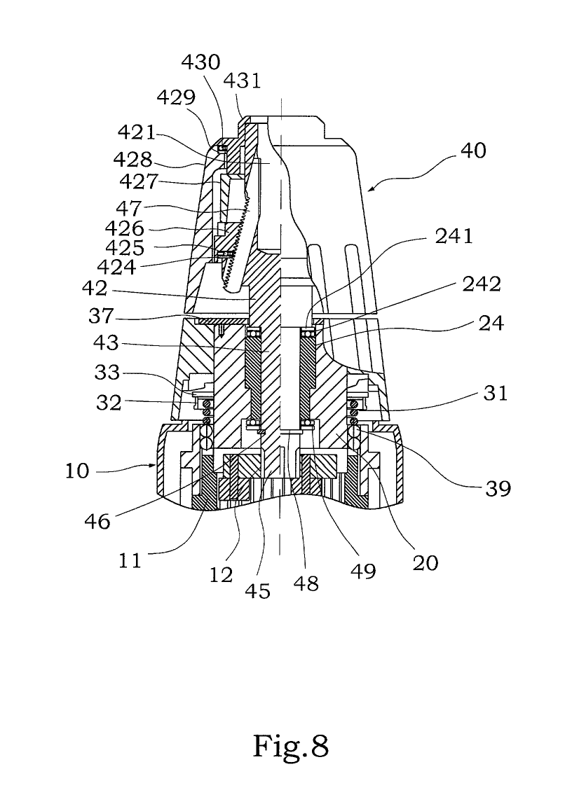

FIGS. 8 shows another alternate form of the present invention. According to this alternate form, the rear extension coupling rod 43 of the driving shaft 42 comprises a locating groove 46 extended around the periphery, a C-shaped retaining ring 48 and a ball bearing washer 49 mounted in the locating groove 46 to secure the driving shaft 42 to the inside of the front coupling tube 21 of the coupling block 20.

A prototype of power hand drill has been constructed with the features of FIGS. 2˜8. The power hand drill functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A power hand drill comprising:
a motor housing, said motor housing holding a motor, said motor having a toothed coupling hole in an output end thereof;
a coupling block fixedly fastened to a front side of said motor housing,
a driving shaft, said driving shaft having a front end mounted with a chuck unit adapted to secure a bit to the front end of said driving shaft and a rear end terminating in a rear extension coupling rod, said rear extension coupling rod comprising a toothed coupling end inserted with said rear extension coupling rod through said coupling block and engaged into the toothed coupling hole of the output end of said motor of said motor housing; and
a positioning structure installed in said coupling block and adapted to secure the connection between the toothed coupling end of said rear extension coupling rod of said driving shaft and the toothed coupling hole of the output end of said motor of said motor housing.

2. The power hand drill of claim 1 wherein said positioning structure comprises an annular groove extending around the periphery of the rear extension coupling rod of said driving shaft, a mounting hole radially extending through said coupling block, a steel ball inserted through the mounting hole of said coupling block, and a holding down screw threaded into the mounting hole of said coupling block to force said steel ball partially into engagement with the annular groove at the rear extension coupling rod of said driving shaft.

3. The power hand drill of claim 1 wherein said driving shaft comprises a locating groove extended around the periphery of said rear extension coupling rod, a ball bearing washer mounted in said locating groove and stopped against an inside wall of said coupling block to prohibit said driving shaft from axial movement relative to said coupling block, and a C-shaped retaining ring mounted in said locating groove to secure said ball bearing washer in position.

4. A power hand drill comprising:
a motor housing, said motor housing holding a motor, said motor having a toothed coupling hole in an output end thereof;
a coupling block fixedly fastened to a front side of said motor housing,
an oil-contained bushing mounted in said coupling block;
a driving shaft, said driving shaft having a front end mounted with a chuck unit adapted to secure a bit to the front end of said driving shaft and a rear end terminating in a rear extension coupling rod, said rear extension coupling rod comprising a toothed coupling end inserted with said rear extension coupling rod through said oil-contained bushing and engaged into the toothed coupling hole of the output end of said motor of said motor housing; and
a positioning structure installed in said coupling block and adapted to secure the connection between the toothed coupling end of said rear extension coupling rod of said driving shaft and the toothed coupling hole of the output end of said motor of said motor housing.

5. The power hand drill of claim 4 wherein said positioning structure comprises an annular groove extending around the periphery of the rear extension coupling rod of said driving shaft, a mounting hole radially extending through said coupling block, a through hole radially extending through said oil-contained bushing corresponding to said mounting hole, a steel ball inserted through the mounting hole on said coupling block into the through hole on said oil-contained bushing, and a holding down screw threaded into the mounting hole on said coupling block to force said steel ball partially into engagement with the annular groove at the rear extension coupling rod of said driving shaft.

6. The power hand drill of claim 5 wherein said oil-contained bushing comprises an inside annular groove extended around an inside wall thereof and holding with the annular groove at the rear extension coupling rod of said driving shaft a plurality of steel balls.

7. The power hand drill of claim 4 wherein said driving shaft comprises a locating groove extended around the periphery of said rear extension coupling rod, a ball bearing washer mounted in said locating groove and stopped against an inside wall of said coupling block to prohibit said driving shaft from axial movement relative to said coupling block, and a C-shaped retaining ring mounted in said locating groove to secure said ball bearing washer in position.

8. The power hand drill of claim 1 wherein said coupling block comprises a longitudinal groove on an inside wall thereof, and said oil-contained bushing comprises a longitudinal rib coupled to the longitudinal groove of said coupling block.

9. A power hand drill comprising:
a motor housing, said motor housing holding a motor, said motor having a toothed coupling hole in an output end thereof;
a coupling block fixedly fastened to a front side of said motor housing,
an oil-contained bushing mounted in said coupling block;
a torque adjustment ring mounted on said coupling block;
a driving shaft, said driving shaft having a front end mounted with a chuck unit adapted to secure a bit to the front end of said driving shaft and a rear end terminating in a rear extension coupling rod, said rear extension coupling rod comprising a toothed coupling end inserted with said rear extension coupling rod through said oil-contained bushing and engaged into the toothed coupling hole of the output end of said motor of said motor housing; and
a positioning structure installed in said coupling block and adapted to secure the connection between the toothed coupling end of said rear extension coupling rod of said driving shaft and the toothed coupling hole of the output end of said motor of said motor housing.

10. The power hand drill of claim 9 wherein said positioning structure comprises an annular groove extending around the periphery of the rear extension coupling rod of said driving shaft, a through hole radially extending through said torque adjustment ring, a mounting hole radially extending through said coupling block corresponding to the through hole on said torque adjustment ring, a through hole radially extending through said oil-contained bushing corresponding to the mounting hole on said coupling block and the through hole on said torque adjustment ring, a steel ball inserted through the through hole on said torque adjustment ring and the mounting hole on said coupling block into the through hole on said oil-contained bushing, and a holding down screw inserted through the through hole on said torque adjustment ring and threaded into the mounting hole on said coupling block to force said steel ball partially into engagement with the annular groove at the rear extension coupling rod of said driving shaft.

11. The power hand drill of claim 9 wherein said oil-contained bushing comprises an inside annular groove extended around an inside wall thereof across the through hole on said oil-contained bushing and holding with the annular groove at the rear extension coupling rod of said driving shaft a plurality of steel balls.

12. The power hand drill of claim 9 wherein said driving shaft comprises a locating groove extended around the periphery of said rear extension coupling rod, a ball bearing washer mounted in said locating groove and stopped against an inside wall of said coupling block to prohibit said driving shaft from axial movement relative to said coupling block, and a C-shaped retaining ring mounted in said locating groove to secure said ball bearing washer in position.
